(19) United States
(12) Patent Application Publication
(10) Pub. No.: US 2012/0326732 A1
(43) Pub. Date: Dec. 27, 2012

(54) NANOSENSOR AND METHOD OF DETECTING TARGET MOLECULE BY USING THE SAME

(75) Inventors: Seong-ho CHO, Gwacheon-si (KR); Dong-ho LEE, Seongnam-si (KR); Jeo-young SHIM, Yongin-si (KR)

(73) Assignee: SAMSUNG ELECTRONIC CO., LTD., Suwon-si (KR)

(21) Appl. No.: 13/475,643

(22) Filed: May 18, 2012

(30) Foreign Application Priority Data
Jun. 27, 2011 (KR) 10-2011-0062483

(51) Int. Cl. G01N 27/04; G01N 27/02; G01N 27/22

(52) U.S. Cl. 324/654; 324/658; 324/692

(57) ABSTRACT

The present disclosure includes a sensor and method for detecting a target molecule. In one instance, a sensor comprises a substrate including a hole, a first insulating layer located on the substrate and including a first nanopore corresponding to the hole, a first electrode, a second electrode, wherein the first electrode and the second electrode are located on a surface of the first insulating layer and are spaced apart by the first nanopore forming a nanogap, and a modulation unit configured to apply a unit input signal between the first electrode and the second electrode, wherein at least one unit input signal is applied as a target molecule passes through the nanogap.

### CROSS-REFERENCE TO RELATED APPLICATIONS

This application claims the benefit of Korean Patent Application No. 10-2011-0062483, filed on Jun. 27, 2011, in the Korean Intellectual Property Office, the disclosure of which is incorporated herein in its entirety by reference.

### BACKGROUND

A Maxam-Gilbert method or Sanger method is typically used to determine the order of bases of deoxyribonucleic acid (DNA). The Maxam-Gilbert method is a method of determining the order of bases of DNA by randomly performing cleavage at specific bases and separating DNA strands having different lengths by using electrophoresis. The Sanger method is a method of determining the order of bases of DNA by synthesizing a complementary DNA by putting a template DNA, a DNA polymerase, a primer, a normal deoxynucleotide triphosphate (dNTP), and a dideoxynucleotide triphosphate (ddNTP) into a tube. When the ddNTP is added while the complementary DNA is synthesized, DNA synthesis is terminated, to obtain complementary DNAs having different lengths, so that the order of bases of DNA may be determined by separating the complementary DNAs having different lengths by using electrophoresis. However, such methods used to determine the order of bases of DNA are time and effort-consuming. Accordingly, there is a need for new DNA sequencing methods.

### SUMMARY

According to an aspect of the present invention, a nanosensor includes: a substrate including a hole; a first insulating layer disposed on at least a portion of the substrate and having a first nanopore corresponding to the hole; first and second electrodes disposed on the first insulating layer and spaced apart from each other about the first nanopore to provide a nanogap between the first and second electrodes; and a modulation unit configured to apply a unit input signal between the first and second electrodes at least one time as a target molecule passes through the nanogap.

The nanosensor may further include first and second electrode pads disposed on at least a portion of the first and second electrodes, respectively.

The nanosensor may further include a second insulating layer disposed on at least a portion of the first and second electrodes and having a second nanopore connected to the first nanopore in the substrate.

Each of the first and second electrodes may comprise graphene or carbon nanotubes.

The nanosensor may further comprise a measurement unit configured to measure a unit output signal corresponding to the unit input signal.

The nanosensor may further include a control unit configured to compare the unit input signal to the unit output signal.

The target molecule may include at least one monomer, and the modulation unit is configured to apply the unit input signal when the at least one monomer (or when each monomer) passes through the nanogap.

The unit input signal may include at least one type of electrical signal.

The unit input signal may include three or more different types of electrical signals.

The electrical signal may include an electrical signal that causes resonant tunneling when the target molecule passes through the nanogap.

The target molecule may include at least one monomer, and the electrical signal may include an electrical signal that causes resonant tunneling when the at least one monomer passes through the nanogap.

The at least one monomer may include at least one of adenine (A), guanine (G), cytosine (C), thymine (T), and uracil (U).

The electrical signal may include a pulse-wave signal.

The modulation unit may be configured to apply a voltage to the nanogap, and the measurement unit configured to measure a tunneling current corresponding to the voltage at the nanogap.

According to another aspect of the present invention, a method of detecting a target molecule by using the nanosensor is provided. The method comprises introducing a target molecule into the nanosensor, specifically, into the nanogap of the nanosensor. The method may further include: applying a unit input signal between the first and second electrodes (across the nanogape) at least one time as the target molecule passes through the nanogap; measuring a unit output signal corresponding to the unit input signal; and detecting the target molecule by comparing the unit input signal with the unit output signal.

The target molecule may include at least one monomer, and the unit input signal may be applied as the at least one monomer passes through the nanogap, or as each of multiple monomers pass through the nanogap.

The unit input signal may include at least one type of electrical signal.

The unit input signal may include three or more types of electrical signals.

The target molecule may include at least one monomer, and the electrical signals may include an electrical signal that causes resonant tunneling when the at least one monomer passes through the nanogap.

The at least one monomer may include at least one of A, G, C, T, and U.

A voltage may be applied to the nanogap, and a tunneling current corresponding to the voltage may be measured at the nanogap.

The electrical signals may include a pulse-wave signal.

The target molecule may be detected by obtaining at least one of a conductance, a capacitance, an inductance, and an impedance at the nanogap from the voltage and the tunneling current.

The target molecule may be detected by obtaining a differential rate of change or an integral rate of change of at least one of a conductance, a capacitance, an inductance, and an impedance at the nanogap from the voltage and the tunneling current.

The tunneling current may be measured by changing at least one of an amplitude, a phase, a time duration, a bandwidth, and a duty cycle of the voltage.

Additional aspects will be set forth in part in the description which follows and, in part, will be apparent from the description, or may be learned by practice of the presented embodiments.

### BRIEF DESCRIPTION OF THE DRAWINGS

These and/or other aspects will become apparent and more readily appreciated from the following description of the embodiments, taken in conjunction with the accompanying drawings of which:

FIG. 1A is a plan view illustrating a nanosensor according to an embodiment of the present invention;

FIG. 1B is a cross-sectional view taken along line A-A′ of the nanosensor of FIG. 1A;

FIG. 2 is a block diagram illustrating the nanosensor of FIG. 1A;

FIG. 3 is a cross-sectional view for explaining an operation of the nanosensor of FIG. 1A;

FIG. 4 is a graph illustrating an input signal applied by a modulation unit of the nanosensor of FIG. 1A;

FIGS. 5A and 5B are graphs illustrating a unit input signal applied by the modulation unit and a unit output signal measured by a measurement unit of the nanosensor of FIG. 1A, according to an embodiment of the present invention;

FIGS. 6A and 6B are graphs illustrating a unit input signal applied by the modulation unit and a unit output signal measured by the measurement unit of the nanosensor of FIG. 1A, according to another embodiment of the present invention; and

FIG. 7 is a block diagram illustrating a control unit of the nanosensor of FIG. 1A.

### DETAILED DESCRIPTION

Various exemplary embodiments will now be described more fully with reference to the accompanying drawings in which some exemplary embodiments are shown.

Detailed illustrative exemplary embodiments are disclosed herein. However, specific structural and functional details disclosed herein are merely representative for purposes of describing exemplary embodiments. This invention may, however, may be embodied in many alternate forms and should not be construed as limited to only the exemplary embodiments set forth herein.

Accordingly, while exemplary embodiments are capable of various modifications and alternative forms, embodiments thereof are shown by way of example in the drawings and will herein be described in detail. It should be understood, however, that there is no intent to limit exemplary embodiments to the particular forms disclosed, but on the contrary, exemplary embodiments are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of exemplary embodiments. As used herein, the term “and/or,” includes any and all combinations of one or more of the associated listed items.

It will be understood that when an element or layer is referred to as being “formed on,” another element or layer, it may be directly or indirectly formed on the other element or layer. That is, for example, intervening elements or layers may be present. In contrast, when an element or layer is referred to as being “directly formed on,” to another element, there are no intervening elements or layers present. Other words used to describe the relationship between elements or layers should be interpreted in a like fashion (e.g., “between,” versus “directly between,” “adjacent,” versus “directly adjacent,” etc.).

The terminology used herein is for the purpose of describing particular embodiments only and is not intended to be limiting of exemplary embodiments. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

In the drawings, the thicknesses of layers and regions are exaggerated for clarity. Like reference numerals in the drawings denote like elements.

The present invention will now be described more fully with reference to the accompanying drawings, in which exemplary embodiments of the invention are shown. In the drawings, the same elements are denoted by the same reference numerals. Sizes of elements in the drawings may be exaggerated for clarity and convenience.

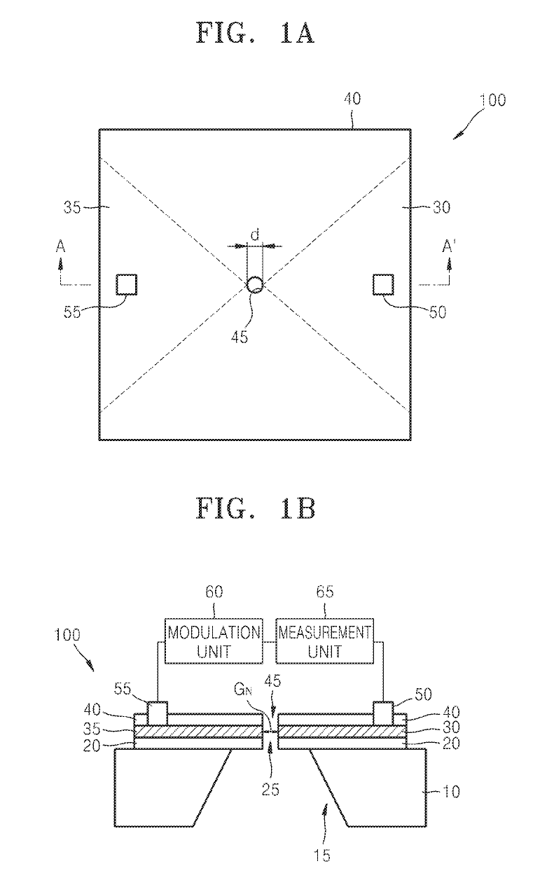

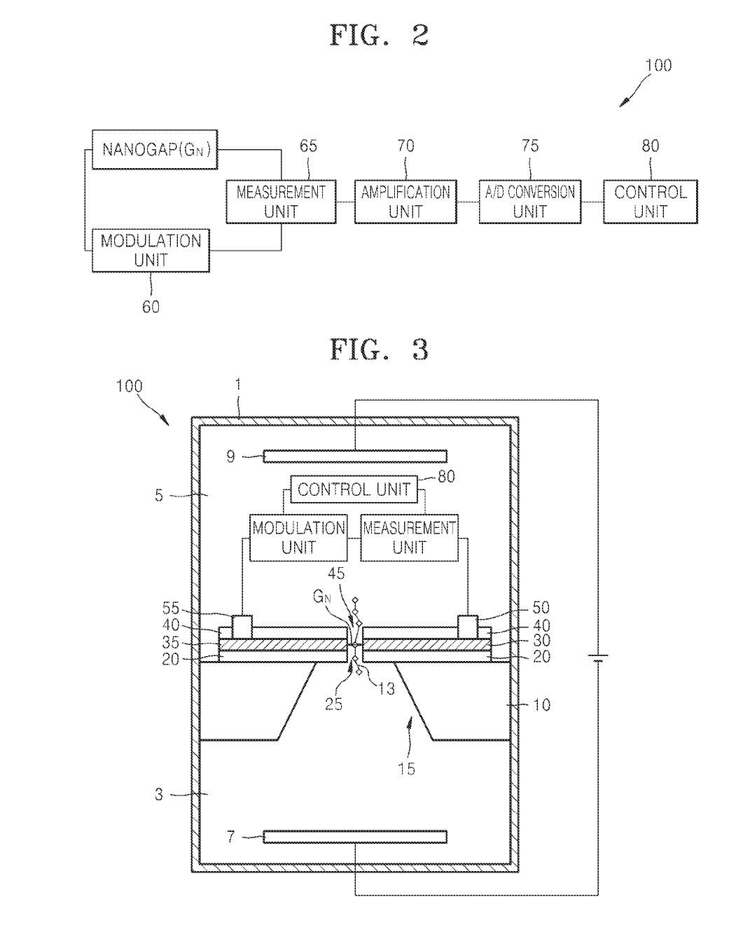

FIG. 1A is a plan view of a nanosensor 100 according to an embodiment of the present invention. FIG. 1B is a cross-sectional view taken along line A-A′ of the nanosensor 100 of FIG. 1A.

Referring to FIGS. 1A and 1B, the nanosensor 100 may include a first insulating layer 20 disposed on a substrate 10, first and second electrodes 30 and 35 disposed on the first insulating layer 20, and a modulation unit 60 connected to the first and second electrodes 30 and 35. The nanosensor 100 may further include first and second electrode pads 50 and 55 respectively disposed on the first and second electrodes 30 and 35, and a second insulating layer 40 disposed on the first and second electrodes 30 and 35. Also, the nanosensor 100 may further include a measurement unit 65 connected to the first and second electrodes 30 and 35.

The substrate 10 may support the first insulating layer 20, the first and second electrodes 30 and 35, the first and second electrode pads 50 and 55, and the second insulating layer 40 on a top surface of the substrate 10. The substrate 10 may be formed of a semiconductor material, a polymer material, or the like. Examples of the semiconductor material may include, for example, silicon (Si), germanium (Ge), gallium arsenide (GaAs), gallium nitride (GaN), and so on, and examples of the polymer material may include an organic polymer and an inorganic polymer. Alternatively, the substrate 10 may be formed of quartz, glass, or the like. A thickness of the substrate 10 may range from tens of micrometers (μm) to hundreds of μm. For example, a thickness of the substrate 10 may range from about 10 μm to about 500 μm, and more specifically, may range from about 200 μm to about 400 μm.

A hole 15 may be formed in the substrate 10. The hole 15 may be formed by using wet etching, for example, buffered oxide etching (BOE), tetramethylammonium hydroxide (TMAH), or the like. A diameter of the hole 15 may be equal to or less than hundreds of μm. For example, a diameter of the hole 15 may range from about 30 μm to about 490 μm, and more specifically, from about 60 μm to about 460 μm. The hole 15 may be formed by using selective etching, and may become narrower from a bottom surface of the substrate 10 toward the top surface of the substrate 10 on which the first insulating layer 20 is disposed. In other words, the hole 15 may be formed to have a tapered shape that becomes narrower from a lower portion toward an upper portion of the substrate 10.

The first insulating layer 20 may be disposed on the substrate 10 to cover the hole 15. The first insulating layer 20 may be formed of, for example, an oxide or a nitride, and more specifically, SiN, SiO₂, Al₂O₃, TiO₂, BaTiO₃, PbTiO₃, BN, or a compound thereof. The first insulating layer 20 may be formed as a thin film having a thickness equal to or less than tens of nanometers (nm). In other words, a thickness of the first insulating layer 20 may range from about 10 nm to about 100 nm. If the first insulating layer 20 is formed of a nitride, a nanopore as will explained below may be easily formed.

A first nanopore 25 may be formed in the first insulating layer 20. The first nanopore 25 may be connected to the hole 15 formed in the substrate 10. In other words, the first nanopore 25 may be formed in a region corresponding to the hole 15. A size of the first nanopore 25 may be determined according to a size of a target molecule to be detected or sequenced. A diameter ‘d’ of the first nanopore 25 may range from several nm to tens of nm. For example, the diameter ‘d’ of the first nanopore 25 may range from about 1 nm to about 100 nm, and more specifically, from about 2 nm to about 10 nm. The first nanopore 25 may be formed by using, for example, a transmission electron microscope (TEM), a scanning electron microscope (SEM), or the like. More specifically, the first nanopore 25 may be formed by using an electron beam, a focused ion beam, a neutron beam, an X-ray, a γ-ray, or the like.

The first and second electrodes 30 and 35 may be disposed on the first insulating layer 20. The first and second electrodes 30 and 35 may be spaced apart from each other with the first nanopore 25 therebetween. The first and second electrodes 30 and 35 may be symmetrical about the first nanopore 25, and a nanogap G_{N} may be formed between the first and second electrodes 30 and 35. A size of the nanogap G_{N} may be equal to or less than about 100 nm, for example, equal to or greater than a size of a target molecule passing through the first nanopore 25. A size of the nanogap G_{N} may range from, for example, about 1 nm to about 100 nm, and more specifically, may range from about 2 nm to about 10 nm. Also, a size of the nanogap G_{N} may be equal to or greater than the diameter ‘d’ of the first nanopore 25. In FIG. 1B, a size of the nanogap G_{N} is equal to the diameter ‘d’ of the first nanopore 25.

The first and second electrodes 30 and 35 may have polygonal shapes such as triangular shapes, as shown in FIG. 1A. However, the present embodiment is not limited thereto, and the first and second electrodes 30 and 35 may have other various shapes. Ends of the first and second electrodes 30 and 35 which face each other to form the nanogap G_{N} may be sharp in order to form the nanogap G_{N}. Each of the first and second electrodes 30 and 35 may be formed of graphene or carbon nanotubes (CNTs). Each of the first and second electrodes 30 and 35 may have a structure including one graphene sheet or a plurality of stacked graphene sheets.

Graphene is an allotrope of carbon, of which a structure is one-atom-thick planar sheet of sp²-bonded carbon atoms that are densely packed in a honeycomb crystal lattice. Graphene is a conductive material and a single graphene layer has a thickness of, for example, about 0.34 nm. Graphene, which is structurally and chemically stable and an excellent conductor, has higher charge mobility than silicon (Si) and may enable more current to flow than copper. CNTs are allotropes of carbon with a cylindrical nanostructure. The chemical bonding of CNTs is composed of sp² bonds, similar to those of graphite.

A thickness of each of the first and second electrodes 30 and 35 may be equal to or less than about 3.4 nm, and more specifically, equal to or less than about 1 nm. If each of the first and second electrodes 30 and 35 is formed of graphene, each of the first and second electrodes 30 and 35 more accurately distinguish a target molecule because each of the first and second electrodes 30 and 35 has higher conductivity than a metal electrode and has a low thickness. In particular, a thickness of one graphene sheet is similar to a size of one base constituting DNA. Each of the first and second electrodes 30 and 35 may be formed of a conductive material. Each of the first and second electrodes 30 and 35 may be formed of, for example, copper (Cu), aluminum (Al), gold (Au), silver (Ag), chromium (Cr), or a mixture thereof.

The first and second electrode pads 50 and 55 may be respectively disposed on the first and second electrodes 30 and 35. The first and second electrode pads 50 and 55 may have polygonal shapes such as quadrangular (e.g., rectangular) shapes as shown in FIG. 1A. However, the present embodiment is not limited thereto, and the first and second electrode pads 50 and 55 may have other various shapes. The first and second electrode pads 50 and 55 may be spaced apart from each other by a gap greater than the nanogap G_{N} formed by the first and second electrodes 30 and 35. However, in order to efficiently apply a voltage or current from an external power source to the first and second electrodes 30 and 35, a contact area between the first and second electrode pads 50 and 55 and the first and second electrodes 30 and 35 may be maximized. Each of the first and second electrode pads 50 and 55 may be formed of a conductive material, for example, gold (Au), chromium (Cr), copper (Cu), nickel (Ni), cobalt (Co), iron (Fe), silver (Ag), aluminum (Al), titanium (Ti), palladium (Pd), or a mixture thereof.

The second insulating layer 40 may be further disposed on the first and second electrodes 30 and 35. The second insulating layer 40 may cover the first insulating layer 20 and the first and second electrodes 30 and 35. The second insulating layer 40 may insulate the first and second electrodes 30 and 35 and expose the first and second electrode pads 50 and 55. The second insulating layer 40 may be formed of an oxide or a nitride, for example, SiN, SiO₂, Al₂O₃, TiO₂, BaTiO₃, PbTiO₃, BN, or a compound thereof. The second insulating layer 40 may be formed as a thin film having a thickness equal to or less than about tens of nm. In other words, a thickness of the second insulating layer 40 may range from about 10 nm to about 100 nm. A second nanopore 45 may be formed in the second insulating layer 40. The second nanopore 45 may be connected to the first nanopore 25 formed in the first insulating layer 20. That is, the first and second nanopores 25 and 45 may form one nanopore, and sizes of the first and second nanopores 25 and 45 may be equal to each other. Also, the first and second nanopores 25 and 45 may be simultaneously formed in the first and second insulating layers 20 and 40, respectively. If the second insulating layer 40 is formed of a nitride, the second nanopore 45 may be easily formed.

The modulation unit 60 may be connected to the first and second electrodes 30 and 35. The modulation unit 60 may be electrically connected to the first and second electrodes 30 and 35 through the first and second electrode pads 50 and 55. The modulation unit 60 may apply a unit input signal between the first and second electrodes 30 and 35, that is, across the nanogap G_{N}. Also, when a target molecule passes through the nanogap G_{N}, the modulation unit 60 may apply once, at least once, or may repeatedly apply, a unit input signal to the nanogap G_{N}. The unit input signal may include at least one type of electrical signal, and more specifically may include three or more types of electrical signals. The electrical signal may include an electrical signal that causes resonant tunneling when a target molecule passes through the nanogap G_{N}. The resonant tunneling is a phenomenon where when energy levels of quantized electrons in two wells are the same, an electron tunneling rate is rapidly increased.

For example, the modulation unit 60 may apply a unit input voltage to the nanogap G_{N} when a target molecule passes through the nanogap G_{N}. The unit input voltage may include various types of pulse-wave voltages having different amplitudes and phases. More specifically, the unit input voltage may include a pulse-wave voltage that causes resonant tunneling when a target molecule passes through the nanogap G_{N}.

If a target molecule includes at least one monomer, the modulation unit 60 may apply a unit input signal whenever the at least one monomer is located at the nanogap G_{N}. That is, whenever the monomer is located at the nanogap G_{N}, the modulation unit 60 may apply once, at least once, or may repeatedly apply, a unit input signal. The unit input signal may include at least one type of electrical signal, and more specifically, may include three or more types of electrical signals. The electrical signal may include an electrical signal that causes resonant tunneling when the monomer passes through the nanogap G_{N}. Also, the electrical signal may include a pulse-wave electrical signal, for example, a pulse-wave bias voltage.

Examples of a target molecule may include a single-stranded DNA, a double-stranded DNA, a single-stranded ribonucleic acid (RNA), a double-stranded RNA, a peptide nucleic acid (PNA), and a polypeptide. For example, if a target molecule is a single-stranded DNA, the monomer may include at least one of bases adenine (A), guanine (G), cytosine (C), and thymine (T) or uracil (U). That is, the unit input signal may include an electrical signal that causes resonant tunneling when at least one of the bases A, G, C, and T (or U) passes through the nanogap G_{N}. Also, the electrical signal may include a pulse-wave electrical signal. More specifically, the unit input signal may include a pulse-wave voltage that causes resonant tunneling when at least one of the bases A, G, C, and T (or U) passes through the nanogap G_{N}. More particularly, the unit signal may include three or more types of electrical signals, such as three or more different pulse-wave electrical signals (e.g., pulse-wave voltages) selected so that the unit signal can be used to differentiate between the different bases. For example, the unit signal could include an electrical signal (e.g., pulse-wave voltage) that induces a tunneling current in base A to a significantly (e.g., measurably) greater or lesser degree than in any of bases G, C or T (or U). In addition, or instead, the unit signal may include an electrical signal (e.g., pulse-wave voltage) that induces a tunneling current in base G to a significantly (e.g., measurably) greater or lesser degree than in any of bases A, C or T (or U). The unit signal similarly may include an electrical signal (e.g., pulse-wave voltage) that induces a tunneling current in base C to a significantly (e.g., measurably) greater or lesser degree than in any of bases A, G, or T (or U); and/or the unit signal may include an electrical signal that induces a tunneling current in base T (or U in the case of RNA) to a significantly (e.g., measurably) greater or lesser degree than in any of bases A, G, or C. By using a unit signal including at least three or four such signals, the unit signal would be capable of distinguishing between each of the four bases of a nucleic acid molecule. Alternatively, the signal could comprise only one such electrical signal, but multiple sensors (e.g., three or four sensors) each using a different signal could be used together, in series or in parallel, to achieve a similar result. The measurement unit 65 may be connected to the first and second electrodes 30 and 35, and may be connected in parallel or in series to the modulation unit 60. The measurement unit 65 may be electrically connected to the first and second electrodes 30 and 35 through the first and second electrode pads 50 and 55. The measurement unit 65 may measure a unit output signal corresponding to the unit input signal applied by the modulation unit 60 between the first and second electrodes 30 and 35. When a target molecule passes between the first and second electrodes 30 and 35, that is, when the target molecule is located at the nanogap G_{N}, the measurement unit 65 may measure a unit output signal at the nanogap G_{N}. Since the unit output signal corresponds to the unit input signal, the unit output signal may include a number of electrical signals equal to a number of electrical signals included in the unit input signal. That is, the unit output signal may include at least one type of electrical signal, and more specifically, may include three or more types of electrical signals. The electrical signal may include a pulse-wave electrical signal. More specifically, the electrical signal may be a tunneling current at the nanogap G_{N} when a target molecule is located at the nanogap G_{N}, and a pulse-wave tunneling current at the nanogap G_{N}.

If a target molecule includes at least one monomer, the measurement unit 65 may measure a unit output signal whenever the at least one monomer is located at the nanogap G_{N}. That is, the measurement unit 65 may repeatedly measure a unit output signal when the monomer is located at the nanogap G_{N}. For example, if a target molecule is a single-stranded DNA or RNA, the monomer may include at least one of bases A, G, C, and T (or U in the case of RNA). Typically, such a DNA or RNA molecule will comprise multiple such bases. In this case, the unit output signal may include an electrical signal that is amplified by resonant tunneling when at least one of the bases A, G, C, and T (or U) passes through the nanogap G_{N}. The electrical signal may include a pulse-wave electrical signal. More specifically, the unit output signal may include a pulse-wave tunneling current that is amplified by resonant tunneling when at least one of the bases A, G, C, and T (or U) passes through the nanogap G_{N}. In some embodiments, the unit imput signal comprises multiple electrical signals (e.g., pulse-voltage signals) each of which induce a tunneling current that is amplified by resonant tunneling to a greater or lesser extent in one of the bases than in the others. In this case, the identity of the base can be distinguished from the other bases by detecting a difference in the unit input and unit output signals, or by identifying which electrical signal component of the unit input signal is amplified or diminished relative to the other components of the signal.

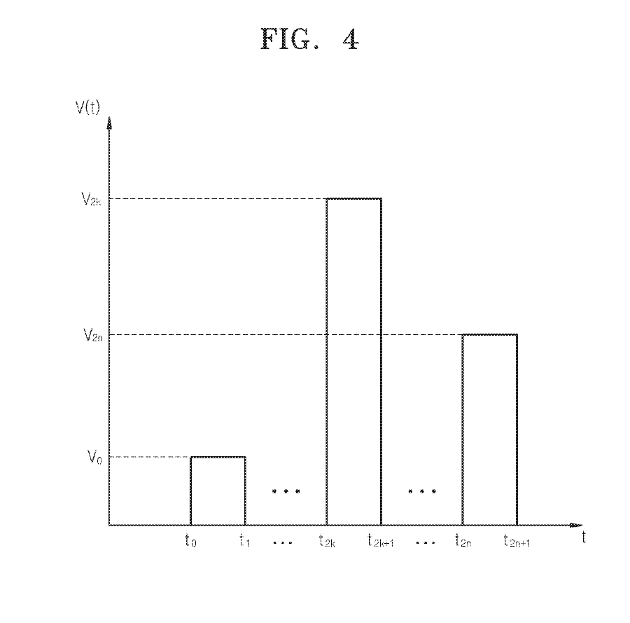

FIG. 2 is a block diagram illustrating the nanosensor 100 of FIG. 1A.

Referring to FIG. 2, the nanosensor 100 may include the nanogap G_{N}, the modulation unit 60, and the measurement unit 65. Also, the nanosensor 100 may further include an amplification unit 70, an analog/digital (A/D) conversion unit 75, and a control unit 80. The nanogap G_{N} is an interval having a nano size and formed between the first and second electrodes 30 and 35 of FIG. 1B, and the modulation unit 60 and the measurement unit 65 have been explained above and thus a repeated explanation thereof will not be given.

The amplification unit 70 may receive a unit output signal measured by the measurement unit 65, and amplify the unit output signal. That is, the amplification unit 70 may amplify an electrical signal, more specifically, a pulse-wave tunneling current, measured at the nanogap G_{N}. The amplification unit 70 may transmit the amplified unit output signal to the A/D conversion unit 75.

The A/D conversion unit 75 may receive the amplified unit output signal that is an analog signal from the amplification unit 70, and convert the amplified unit output signal to a digital unit output signal. The A/D conversion unit 75 may transmit the digital unit output signal to the control unit 80.

The control unit 80 may receive the digital unit output signal from the A/D conversion unit 75. The control unit 80 may detect a target molecule by comparing the digital unit output signal with a unit input signal applied to the nanogap G_{N} by the modulation unit 60. The unit input signal may include an electrical signal that causes resonant tunneling when the target molecule passes through the nanogap G_{N}. Accordingly, when the target molecule passes through the nanogap G_{N}, the unit output signal may include an electrical signal amplified by resonant tunneling. The control unit 80 may sense the unit output signal amplified by the resonant tunneling, and determine that the target molecule passes through the nanogap G_{N}. That is, the control unit 80 may detect a target molecule by determining whether a unit input signal corresponding to a measured unit output signal is amplified.

An electrical signal that causes resonant tunneling when a target molecule passes through the nanogap G_{N} may be selected by applying a plurality of electrical signals when a sample molecule, that is, an already known molecule, passes through the nanogap G_{N}. That is, an electrical signal that causes resonant tunneling from among a plurality of electrical signals may be included in a unit input signal.

If a target molecule includes at least one monomer, a unit input signal may include an electrical signal that causes resonant tunneling when the at least one monomer is located at the nanogap G_{N}. The control unit 80 may sense an amplified electrical signal of a unit output signal when the at least one monomer is located at the nanogap G_{N}. The control unit 80 may match the amplified electrical signal to a corresponding electrical signal of a unit input signal. Next, the control unit 80 may match a monomer that causes resonant tunneling to the matched electrical signal of the unit input signal. Accordingly, the control unit 80 may distinguish the very monomer that passes through the nanogap G_{N}.

For example, when a target molecule is a single-stranded DNA or RNA, the monomer may include at least one of bases A, G, C, and T (or U in the case of RNA). A unit input signal may include first through fourth electrical signals that cause resonant tunneling when the bases A, G, C and T pass through the nanogap G_{N}. In this case, a unit output signal may include fifth through eighth electrical signals corresponding to the first and fourth electrical signals.

More specifically, if the base A included in the target molecule is located at the nanogap G_{N}, the first electrical signal of the unit input signal may cause resonant tunneling. That is, the fifth electrical signal corresponding to the first electrical signal applied to the nanogap G_{N} may be amplified and measured. The control unit 80 may determine that the fifth electrical signal of the measured unit output signal is amplified and match the amplified fifth electrical signal to the first electrical signal of the unit input signal. The control unit 80 may match the base A that causes resonant tunneling to the matched first electrical signal. Accordingly, the control unit 80 may determine that the base A passes through the nanogap G_{N}. By repeatedly performing such a process, the nanosensor 100 may distinguish all bases included in the single-stranded DNA that is the target molecule. That is, the nanosensor 100 may sequence the single-stranded DNA that is the target molecule. Accordingly, the nanosensor 100 may rapidly and accurately determine the order of bases of DNA by using a next generation sequencing method without randomly cutting a single-stranded DNA or without performing synthesis and electrophoresis on complementary DNAs, thereby reducing costs.

The control unit 80 may further include a memory device (not shown). A unit input signal and a unit output signal which are digital signals, or converted to digital signals, may be stored in the memory device. Also, characteristics (voltage, amperage, frequency, etc.) of an electrical signal that causes resonant tunneling for a target molecule that is obtained by using a sample molecule may be stored in the memory device. For example, characteristics of a first through fourth electrical signals which cause resonant tunneling when bases A, G, C, and T (or U) pass through the nanogap G_{N} may be stored in the memory device. Also, fifth through eighth electrical signals measured at the nanogap G_{N} may be stored in the memory device.

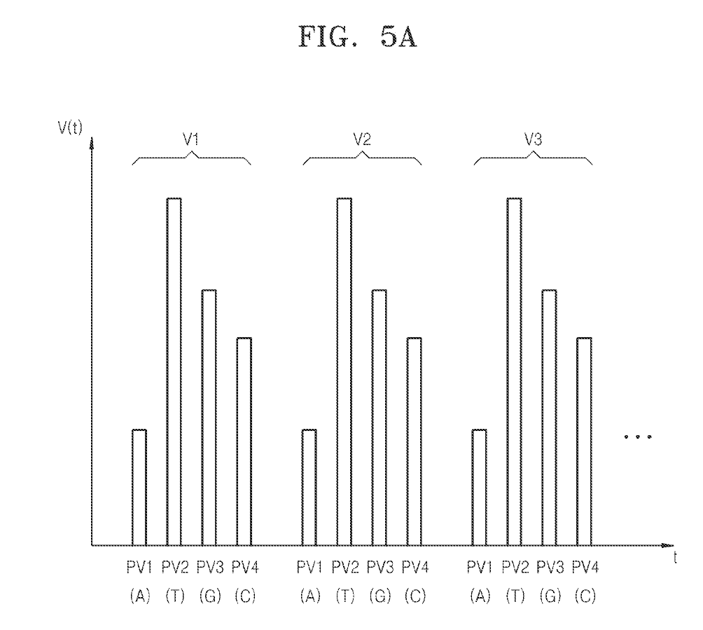

FIG. 3 is a cross-sectional view for explaining an operation of the nanosensor 100 of FIG. 1A.

Referring to FIG. 3, the nanosensor 100 may further include a housing 1 surrounding the substrate and other components formed thereon. The housing 1 may be divided into two regions about the substrate 10. That is, the housing 1 may include a first region 3 disposed on one side (under) the substrate 10 and a second region 5 disposed on the opposide side (over) the substrate 10. The first region 3 and the second region 5 may be connected to each other through the first and second nanopores 25 and 45. Lower and upper electrodes 7 and 9 may be disposed in the first and second regions 3 and 5, respectively. A voltage may be applied to the lower and upper electrodes 7 and 9 from an external power source. The lower electrode 7 may be a negative (−) electrode and the upper electrode 9 may be a positive electrode, or vice versa. The housing 1 may be filled with a buffer solution such as water, deionized water, or an electrolyte solution. The buffer solution may be a medium through which a target molecule moves.

A target molecule may be introduced into the first region 3. The target molecule may be an object to be detected or sequenced. Examples of the target molecule may include a nucleic acid, a protein, or a sugar. More specifically, examples of the target molecule may include a single-stranded DNA, a double-stranded DNA, a single-stranded RNA, a double-stranded RNA, a PNA, and polypeptide. Certain embodiments of the invention are described and illustrated with reference to a DNA molecule. However, such descriptions and illustrations apply equally to the use of any nucleic acid.

A single-stranded DNA 13 is illustrated as a target molecule in FIG. 3. Since the single-stranded DNA 13 is negatively charged, the single-stranded DNA 13 may move from the first region 3 in which the lower electrode 7, which is a negative electrode, is disposed to the second region 5 in which the upper electrode 9, which is a positive electrode, is disposed. That is, the single-stranded DNA 13 introduced into the first region 3 may move to a place close to the hole 15 of the substrate 10 due to an electric field applied to the single-stranded DNA 13. The single-stranded DNA 13 may be guided by the hole 15 to the first nanopore 25. The single-stranded DNA 13 may pass through the first nanopore 25, the nanogap G_{N}, and the second nanpore 45.

When the single-stranded DNA 13 passes through the nanogap G_{N}, the modulation unit 60 may apply a unit input signal and the measurement unit 65 may measure a unit output signal. The control unit 80 may detect or distinguish the single-stranded DNA 13 by comparing the unit input signal with the unit output signal. That is, the control unit 80 may sense an electrical signal amplified due to resonant tunneling and detect or sequence the single-stranded DNA 13. The control unit 80 may detect the single-stranded DNA 13 by matching the amplified electrical signal to an electrical signal measured by using an already known sample molecule.

More specifically, the modulation unit 60 may apply at least one pulse-wave voltage between the first and second electrodes 30 and 35 when at least one monomer, that is, at least one nucleotide, constituting the single-stranded DNA 13 passes through the nanogap G_{N}. The measurement unit 65 may measure a pulse-wave tunneling current corresponding to the voltage applied between the first and second electrodes 30 and 35 when the monomer, that is, the nucleotide, passes through the nanogap G_{N}. The control unit 80 may compare the pulse-wave voltage with the pulse-wave tunneling current. Also, the control unit may distinguish the monomer, that is, the nucleotide, which passes through the nanogap G_{N} by determining whether the tunneling current is amplified. That is, the control unit 80 may match the amplified tunneling current to the corresponding voltage, and may match the corresponding voltage to the monomer, that is, the nucleotide, which causes resonant tunneling. The nanosensor 100 may sequence the single-stranded DNA 13 by repeatedly performing such a process.

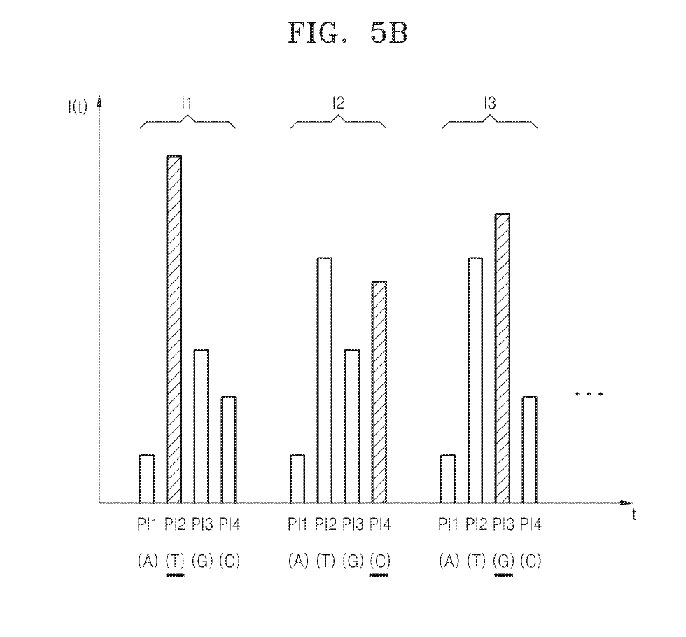

FIG. 4 is a graph illustrating a unit input signal applied by the modulation unit 60 of the nanosensor 100 of FIG. 1A.

As described above, a unit input signal may include at least one type of electrical signal, and more specifically, may include three or more types of electrical signals. The electrical signal may include an electrical signal that causes resonant tunneling when a target molecule passes through the nanogap G_{N}. Also, the electrical signal may include a voltage or a current, and the voltage and the current may be a pulse-wave voltage and a pulse-wave current.

Referring to FIG. 4, a unit input signal may include a plurality of pulse-wave voltages V(t) which satisfy Equation 1:

$$V ( t ) = {\sum }_{k = 0}^{n} {V}_{2 k} [ Θ ( t - {t}_{2 k} ) - Θ ( t - {t}_{2 k + 1} ) ]$$

In Equation 1, V₂ₖ may be an amplitude of a voltage and n may be a number of electrical signals, that is, pulse-wave voltages, included in a unit input signal. If a target molecule includes m types of monomers, n may be equal to or greater than (m−1). As the number n increases, more pulse-wave voltages may be applied to each of monomers constituting the target molecule and more pulse-wave tunneling currents may be measured. Accordingly, each of the monomers may be more accurately distinguished. For example, if a target molecule is a single-stranded DNA or RNA, in order to distinguish 4 types of bases, that is, A, G, C, and T (or U in the case of RNA), the number ‘n’ may be equal to or greater than 4. However, if three of the bases A, G, C, and T (or U) are distinguished, the remaining one may be determined. Accordingly, the number ‘n’ may be equal to or greater than 3. In Equation 1, Θ(t) which is a Heaviside step function may be defined by Equation 2:

$$\begin{matrix}Θ ( t - {t}_{0} ) = 1 , t \geq {t}_{0} \\ = 0 , t < {t}_{0}\end{matrix}$$

Also, a unit output signal when the target molecule passes through the nanogap G_{N} may include a plurality of pulse-wave tunneling currents I(t) which satisfy Equation 3:

I(t)=V(t)·G_{base}(V(t))

In Equation 3, V(t) is a pulse-wave voltage in Equation 1 and G_{base}(t) which is a conductance when a base is located at the nanogap G_{N} is a function about the pulse-wave voltage V(t).

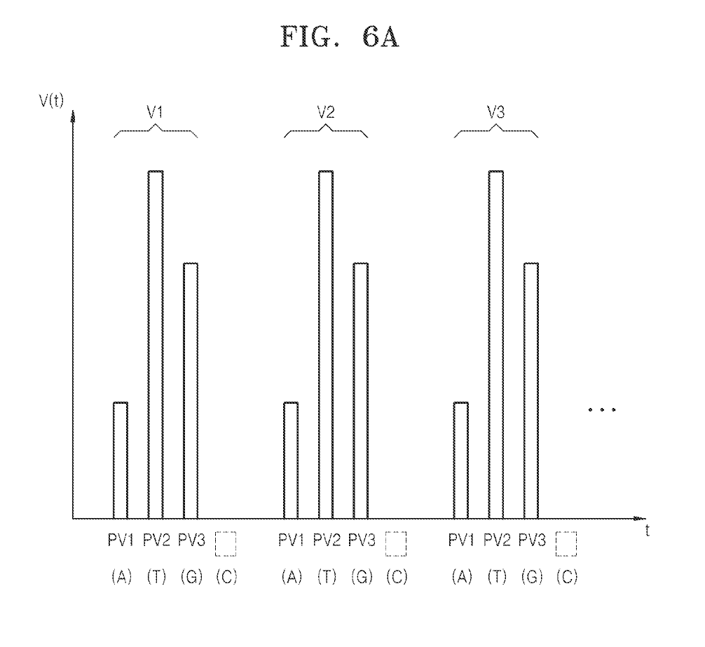

FIGS. 5A and 5B are graphs illustrating a unit input signal applied by the modulation unit 60 and a unit output signal measured by the measurement unit 65 of the nanosensor 100 of FIG. 1A, according to an embodiment of the present invention.

A unit input signal applied by the modulation unit 60 to the nanogap G_{N} may include at least one electrical signal. The electrical signal may be a pulse-wave electrical signal. The electrical signal may be a bias voltage. Also, the electrical signal may be a pulse-wave voltage. A unit output signal measured at the nanogap G_{N} by the measurement unit 65 when a target molecule passes through the nanogap G_{N} may include at least one electrical signal. The electrical signal may be a pulse-wave electrical signal. The electrical signal may be a tunneling current. Also, the electrical signal may be a pulse-wave tunneling current. The at least one electrical signal included in the unit input signal may correspond to the at least one electrical signal included in the unit output signal in a one-to-one manner. In other words, the unit output signal will typically correspond to the unit input signal by comprising the same number and type of electrical signals, or corresponding tunneling currents, although the individual signals of the unit output signal may differ in certain characteristics that allow for detection of the target molecule, as discussed herein. In some instances, however, one or more electrical signals of the unit input signal might not induce a measurable tunneling current in a target molecule, in which case those one or more electrical signals could be absent from the measured unit output signal.

Referring to FIG. 5A, first through third unit input signals V1, V2, and V3 are illustrated. Each of the first through third unit input signals V1, V2, and V3 may be repeatedly applied to the nanogap G_{N} whenever a target molecule or a monomer included in the target molecule is located at the nanogap G_{N}. By way of further illustration, if the target molecule is a nucleic acid (DNA or RNA) passing through the nanogap, V1 is the unit input signal applied as the first base of the nucleic acid reaches and is located at the nanogap, V2 is the unit input signal applied as the second base reaches and is located at the nanogap, and V3 is the unit input signal applied as the third base reaches and is located at the nanogap. The application of additional unit input signals (V4, V5, etc.) could be continued for any desired duration (e.g., the number of basis contained in the target molecule).

Each of the first through third unit input signals V1, V2, and V3 may include first through fourth pulse-wave voltages PV1, PV2, PV3, and PV4. For example, when the target molecule is a nucleic acid, the first through fourth pulse-wave voltages PV1, PV2, PV3, and PV4 may be pulse-wave voltages which cause resonant tunneling when bases A, T (or U), G, and C pass through the nanogap G_{N}, respectively. In other words, PV1 may be a pulse-wave voltage that causes greater resonant tunneling in base A than in bases T (or U), G, or C; PV2 may be a pulse-wave voltage that causes greater resonant tunneling in base T (or U) than in bases A, G, or C; PV3 may be a pulse-wave voltage that causes greater resonant tunneling in base G than in bases A, T (or U), or C; and PV4 may be a pulse-wave voltage that causes greater resonant tunneling in base C than in bases A, T (or U), or G. Furthermore, each of the unit input signals can be the same (e.g., comprise the same pulse-wave voltage components).

Referring to FIG. 5B, first through third unit output signals I1, I2, and I3 corresponding to the first through third unit input signals V1, V2, and V3 are illustrated. Each of the unit output signals I1, I2, and I3 may be measured at the nanogap G_{N} whenever a target molecule or a monomer included in the target molecule is located at the nanogap G_{N}. Each of the unit output signals I1, I2, and I3 may include first through fourth pulse-wave tunneling currents PI1, PI2, PI3, and PI4. For example, the first through fourth pulse-wave tunneling currents PI1, PI2, PI3, and PI4 may be pulse-wave tunneling currents in the unit output signal measured when bases A, T (or U), G, and C, respectively, pass through the nanogap G_{N}.

Examining the first unit output signal I1, it is found that the second pulse-wave tunneling current PI2 corresponding to the second pulse-wave voltage PV2 is amplified. It is found that from among the four bases A, T (or U), G, and C, the second pulse-wave PV2 causes resonant tunneling as the base T (or U) passes through the nanogap G_{N}. Thus, in this instance, the base of the target molecule present at the nanogap when the first unit input signal is applied and the corresponding first unit output signal is measured can be identified as T (or U if RNA) on the basis of the amplified PI2.

Examining the second unit output signal I2, it is found that the fourth pulse-wave tunneling current PI4 corresponding to the fourth pulse-wave voltage PV4 is amplified. It is found that from among the four bases A, T, G, and C, the fourth pulse-wave voltage PV4 causes resonant tunneling as the base C passes through the nanogap G_{N}. Thus, in this instance, the base of the target molecule present at the nanogap when the second unit input signal is applied and the corresponding second unit output signal is measured can be identified as C on the basis of the amplified PI4.

Examining the third unit output signal I3, it is found that the third pulse-wave tunneling current PI3 corresponding to the third pulse-wave voltage PV3 is amplified. It is found that from among the four bases A, T, G, and C, the third pulse-wave voltage PV3 causes resonant tunneling as the base G passes through the nanogap G_{N}. Thus, in this instance, the base of the target molecule present at the nanogap when the third unit input signal is applied and the corresponding third unit output signal is measured can be identified as G on the basis of the amplified PI3. The same process can be repeated for each base in a target molecule to be sequenced.

In this manner, the control unit 80 may compare a unit input signal with a unit output signal and match an amplified pulse-wave current to an applied pulse-wave voltage. Also, the control unit 80 may match the matched pulse-wave voltage to a target molecule or a monomer included in the target molecule which causes resonant tunneling. Accordingly, the control unit 80 may distinguish the target molecule or the monomer included in the target molecule.

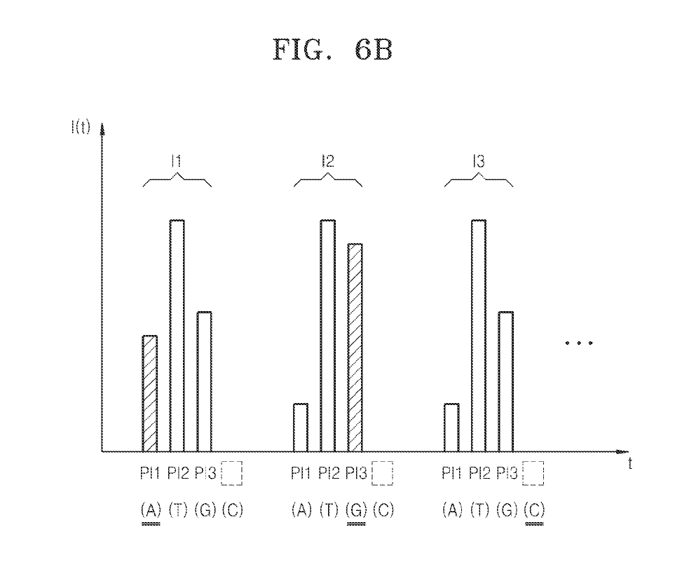

FIGS. 6A and 6B are graphs illustrating a unit input signal applied by the modulation unit 60 and a unit output signal measured by the measurement unit 65 of the sensor 100 of FIG. 1A, according to another embodiment of the present invention.

Referring to FIG. 6A, first through third unit input signals V1, V2, and V3 are illustrated. Unit input signals may be repeatedly applied to the nanogap G_{N} whenever a target molecule or a monomer included in the target molecule is located at the nanogap G_{N}. Each of the unit input signals V1, V2, and V3 may include first through third pulse-wave voltages PV1, PV2, and PV3. For example, the first through third pulse-wave voltages PV1, PV2, and PV3 may be pulse-wave voltages which cause resonant tunneling when bases A, T, and G pass through the nanogap G_{N}, respectively.

Referring to FIG. 6B, first through third unit output signals I1, I2, and I3 corresponding to the first through third unit input signals V1, V2, and V3 are illustrated. Each of the unit output signals I1, I2, and I3 may be measured at the nanogap G_{N} whenever the target molecule or the monomer included in the target molecule is located at the nanogap G_{N}. Each of the unit output signals I1, I2, and I3 may include first through third pulse-wave tunneling currents PI1, PI2, and PI3. For example, the first through third pulse-wave tunneling currents PI1, PI2, and PI3 may be pulse-wave tunneling currents when the bases A, T, and G pass through the nanogap G_{N}, respectively.

Examining the first unit output signal I1, it is found that the first pulse-wave tunneling current PI1 corresponding to the first pulse-wave voltage PV1 is amplified. Since PV1 is the pulse wave voltage that induces resonant tunneling in base A, amplification of the corresponding tunneling current PI1 indicates that base. A was present in the nanogap at the time unit input signal V1 was applied and corresponding first unit output signal I1 was measured. That is, it is found that from among the four bases A, T, G, and C, the base A corresponding to the first pulse-wave voltage PV1 which causes resonant tunneling passes through the nanogap G_{N}.

Examining the second unit output signal I2, it is found that the third pulse-wave tunneling current PI3 corresponding to the third pulse-wave voltage PV3 is amplified. Since PV1 is the pulse wave voltage that induces resonant tunneling in base G, amplification of the corresponding tunneling current PI1 indicates that base G was present in the nanogap at the time the second unit input signal V2 was applied and corresponding second unit output signal I2 was measured. That is, it is found that from among the four bases A, T, G, and C, the base G corresponding to the third pulse-wave voltage PV3 which causes resonant tunneling passes through the nanogap G_{N}.

Examining the third unit output signal I3, it is found that there is no amplified pulse-wave tunneling current. That is, none of the first through third pulse-wave tunneling currents PI1, PI2, and PI3 are amplified. Since PV1, PV2, and PV3 are known to induce tunneling current in bases A, T, and G, respectively, the absence of amplified tunneling current indicates that base C was present in the nanogap at the time the third unit input signal V3 was applied and corresponding third unit output signal I3 was measured. That is, it is found that from among the four bases A, T, G, and C, the base C without corresponding to a pulse-wave voltage which causes resonant tunneling passes through the nanogap G_{N}.

As such, the control unit 80 may compare a unit input signal with a unit output signal and match an amplified pulse-wave current to an applied pulse-wave voltage. Also, the control unit 80 may match the matched pulse-wave voltage to a target molecule or a monomer included in the target molecule which causes resonant tunneling. Also, if all pulse-wave currents are not amplified, the control unit 80 may match a void signal to a remaining target molecule or a monomer included in the remaining target molecule. Accordingly, the control unit 80 may distinguish the target molecule and the monomer included in the target molecule.

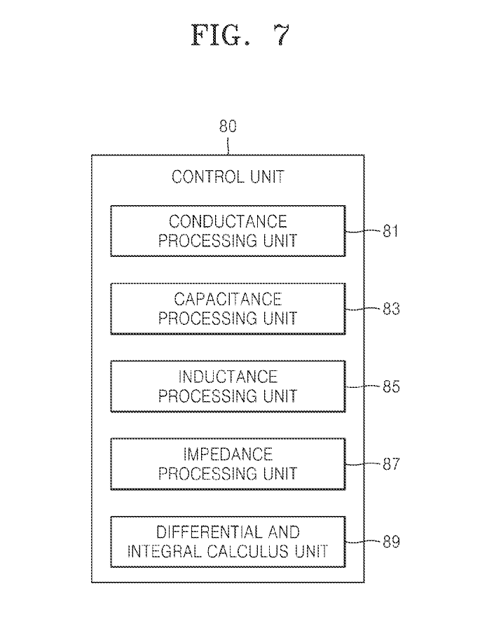

FIG. 7 is a block diagram illustrating the control unit 80 of the sensor 100 of FIG. 1A.

Referring to FIG. 7, the control unit 80 may include at least one of a conductance processing unit 81, a capacitance processing unit 83, an inductance processing unit 85, an impedance processing unit 87, and a differential and integral calculus unit 89. The control unit 80 may detect a target molecule or a monomer included in the target molecule from a pulse-wave voltage applied to the nanogap G_{N} and a pulse-wave tunneling current measured at the nanogap G_{N}. That is, the control unit 80 may detect a target molecule by detecting a change in an amplitude of the voltage and the tunneling current. Alternatively, or in addition, the control unit 80 may detect a target molecule or a monomer included in the target molecule by using a change in a phase of the voltage and the tunneling current. Also, the control unit 80 may detect a target molecule or a monomer included in the target molecule by measuring a change in a conductance, a capacitance, an inductance, or an impedance which may be obtained from the voltage and the tunneling current.

The conductance processing unit 81 may sense a change in a conductance at the nanogap G_{N} from a pulse-wave voltage applied to the nanogap G_{N} and a pulse-wave tunneling current measured at the nanogap G_{N}. That is, the conductance processing unit 81 may detect a target molecule or a monomer included in the target molecule by detecting a change in at least one of an amplitude and a phase of the conductance at the nanogap G_{N}.

The capacitance processing unit 83 may detect a change in a capacitance at the nanogap G_{N} from a pulse-wave voltage applied to the nanogap G_{N} and a pulse-wave tunneling current measured at the nanogap G_{N}. That is, the capacitance processing unit 83 may detect a target molecule or a monomer included in the target molecule by detecting a change in at least one of an amplitude and a phase of the capacitance at the nanogap G_{N}.

The inductance processing unit 85 may detect a change in an inductance at the nanogap G_{N} from a pulse-wave voltage applied to the nanogap G_{N} and a pulse-wave tunneling current measured at the nanogap G_{N}. That is, the inductance processing unit 85 may detect a target molecule or a monomer included in the target molecule by detecting a change in at least one of an amplitude and a phase of the inductance at the nanogap G_{N}.

The impedance processing unit 87 may detect a change in an impedance at the nanogap G_{N} from a pulse-wave voltage applied to the nanogap G_{N} and a pulse-wave tunneling current measured at the nanogap G_{N}. That is, the impedance processing unit 87 may detect a target molecule or a monomer included in the target molecule by detecting a change in at least one of an amplitude and a phase of the impedance at the nanogap G_{N}.

The differential and integral calculus unit 89 may detect a target molecule or a monomer included in the target molecule by measuring a differential rate of change or an integral rate of change of a first or higher order with respect to a time of a pulse-wave voltage applied to the nanogap G_{N} and a pulse-wave tunneling current measured at the nanogap G_{N}. Also, the differential and integral calculus unit 89 may detect a target molecule or a monomer included in the target molecule by measuring a differential rate of change or an integral rate of change of a first or higher order with respect to a time of at least one of a conductance, a capacitance, an inductance, and an impedance at the nanogap G_{N} from the voltage and the tunneling current.

Also, the control unit 80 may perform analysis by applying a linear combination to the voltage and the tunneling current, and the conductance, the capacitance, the inductance, and the impedance at the nanogap G_{N} which are obtained from the voltage and the tunneling current. Examples of the linear combination may include, for example, linear fitting, non-linear fitting, and least square fitting. The control unit 80 also may modulate a bias voltage applied by the modulation unit 60. That is, the control unit 80 may change at least one of an amplitude, a phase, a temporal duration, a bandwidth, and a duty cycle of the bias voltage.

While the present invention has been particularly shown and described with reference to exemplary embodiments thereof, it will be understood by those of ordinary skill in the art that various changes in form and detail may be made therein without departing from the spirit and scope of the present invention as defined by the following claims. The preferred embodiments should be considered in a descriptive sense only and not for purposes of limitation. Therefore, the scope of the invention is defined not by the detailed description of the invention but by the appended claims, and all differences within the scope will be construed as being included in the present invention.

What is claimed is:

1. A nanosensor comprising:
a substrate having a hole;
a first insulating layer disposed on a surface of the substrate and including a first nanopore corresponding to the hole in the substrate;
first and second electrodes disposed on the first insulating layer, wherein the first and second electrodes are spaced apart from each other about the first nanopore and forming a nanogap therebetween; and a modulation unit configured to apply a unit input signal between the first electrode and the second electrodes as a target molecule passes through the nanogap.

2. The nanosensor of claim 1, further comprising:
a first electrode pad disposed on at least a portion of the first electrode; and
a second electrode pad disposed on at least a portion of the second electrode.

3. The nanosensor of claim 1, further comprising:
a second insulating layer disposed on at least a portion of the first and second electrodes and having a second nanopore connected to the first nanopore.

4. The nanosensor of claim 1, wherein each of the first electrode and the second electrode comprises graphene or carbon nanotubes.

5. The nanosensor of claim 1, further comprising:
a measurement unit configured to measure a unit output signal corresponding to the unit input signal applied between the first electrode and the second electrode.

6. The nanosensor of claim 5, further comprising:
a control unit configured to compare the unit input signal to the unit output signal.

7. The nanosensor of claim 1, wherein the target molecule comprises at least one monomer, and the modulation unit applies the unit input signal as the at least one monomer passes through the nanogap.

8. The nanosensor of claim 1, wherein the unit input signal comprises at least one type of electrical signal.

9. The nanosensor of claim 1, wherein the unit input signal comprises three or more types of electrical signals.

10. The nanosensor of claim 9, wherein the three or more types of electrical signals comprise an electrical signal that causes resonant tunneling when the target molecule passes through the nanogap.

11. The nanosensor of claim 9, wherein the target molecule comprises at least one monomer, and the three or more types of electrical signals comprise an electrical signal that causes resonant tunneling when the at least one monomer passes through the nanogap.

12. The nanosensor of claim 11, wherein the at least one monomer comprises at least one of adenine, guanine, cytosine, thymine, and uracil.

13. The nanosensor of claim 9, wherein the three or more types of electrical signals comprise a pulse-wave signal.

14. The nanosensor of claim 5, wherein the modulation unit applies a voltage across the nanogap, and the measurement unit measures a tunneling current corresponding to the voltage applied across the nanogap.

15. A method of detecting a target molecule comprising introducing a target molecule into the nanogap of the nanosensor of claim 1.

16. The method of claim 15, further comprising
applying a unit input signal between the first electrode and the second electrode as the target molecule passes through the nanogap;
measuring a unit output signal corresponding to the unit input signal between the first electrode and the second electrode; and
detecting the target molecule by comparing the unit input signal with the unit output signal.

17. The method of claim 15, wherein the target molecule comprises at least one monomer, and the unit input signal is applied as the at least one monomer passes through the nanogap.

18. The method of claim 15, wherein the unit input signal comprises three or more types of electrical signals.

19. The method of claim 18, wherein the target molecule comprises at least one monomer, and the three or more types of electrical signals comprise an electrical signal that causes resonant tunneling when the at least one monomer passes through the nanogap.

20. The method of claim 18, wherein a voltage is applied across the nanogap, and the method further comprises measuring a tunneling current corresponding to the voltage across the nanogap.

21. The method of claim 18, wherein the three or more types of electrical signals comprise a pulse-wave signal.

22. The method of claim 20, wherein the target molecule is detected by detecting a change in at least one of conductance, capacitance, inductance, and impedance in the tunneling current, or by detecting a differential rate of change or an integral rate of change of at least one of conductance, capacitance, inductance, and impedance in the tunneling current.

23. The nanosensor of claim 1, wherein the unit input signal comprises at least three of
(a) a pulse wave voltage that induces a tunneling current in adenine to a greater degree than in cytosine, guanine, thymine, or uracil;
(b) a pulse wave voltage that induces a tunneling current in cytosine to a greater degree than in adenine, guanine, thymine, or uracil;
(c) a pulse wave voltage that induces a tunneling current in guanine to a greater degree than in adenine, cytosine, thymine, or uracil; and
(d) a pulse wave voltage that induces a tunneling current in thymine or uracil to a greater degree than in adenine, cytosine, or guanine.
